(19) United States
(12) Patent Application Publication
(10) Pub. No.: US 2018/0290774 A1
(43) Pub. Date: Oct. 11, 2018

(54) MOVING FILLING NOZZLES ON A ROTATABLE FORMING MACHINE

(71) Applicant: Rideau Machinery Inc., Aurora, IL (US)

(72) Inventors: James FOWLER, St. Charles, IL (US); Boris MAKUTONIN, Cincinnati, OH (US)

(21) Appl. No.: 15/763,304

(22) PCT Filed: Sep. 26, 2016
(86) PCT No.: PCT/IB2016/055745

§ 371 Date: Mar. 26, 2018

(30) Foreign Application Priority Data
Sep. 24, 2015 (GB) 1516903.0

(51) Int. Cl. B65B 9/04; B29C 51/22; B29C 51/26; B65B 39/00

(52) U.S. Cl. CPC B65B 9/042; B29C 51/225; B29L 2031/712; B65B 39/004; B29C 51/266

(57) ABSTRACT

A rotatable thermoforming machine for producing soluble pockets made from a soluble web. The machine has a plurality of pocket forming cavities 38a, b, c in each of which a respective pocket is formed in the soluble web. The pockets travel in a machine direction defined as the X direction and filling means 44 is arranged to at least partially fill the or each pocket formed in the soluble web. The filling means 44 comprising one or more nozzles 44, each nozzle 44 being arranged to be moveable in at least the X-direction as the or each respective pocket is filled from the filling nozzle 44.

This invention relates to a novel method of controlling filling nozzles during filling. In particular, but not exclusively, this invention relates to continuous motion rotatable thermoforming machines having one or more filling nozzles and to improvements in the arrangement and operation of the machines and the nozzles. The invention also relates to a method of carrying out filling of the thermoformed pouches using the machine and to improved thermoformed packages produced and filled on the thermoforming machine.

In earlier patent applications, WO2011/061628, WO2013/190517 and WO2014/170882, we have claimed a number of inventions relating to continuous motion rotatable thermoforming machines, their method of operation and different designs and constructions of water-soluble pouches capable of being produced thereon.

In our earlier applications we describe continuous motion rotatable thermoforming machines. Continuous motion rotating thermoforming offers a number of advantages compared to intermittent motion horizontal thermoforming. Higher productivity rates can be achieved. However it has been appreciated that a number of problems have to be addressed.

The present invention is intended to overcome or at least to mitigate some of the problems and disadvantages particularly addressing problems in filling compartments, particularly “awkward” shaped compartments in multi-compartment pouches made from two or more water-soluble substrates and in filling multi-compartment pouches made by sealing together two such pouches as described in WO2013/190517 or elsewhere.

In the applicant's earlier patent applications referred to above, the filling nozzles have been fixed or stationary relative to the former. At typical speeds at which the former is continuously moving, fixed or stationary nozzles allow less than one second to complete the fill of each compartment of a multi-compartment pouch. It has been found that, due to the disposition, size and shape of certain types of compartment within the footprint of a multi-compartment pouch, fixed or stationary nozzles are unable to complete the fill of the required amount of powder, granules or liquid into such an awkward shaped compartment within the short time interval available.

As used herein the term “soluble webs” refers to webs of polymeric substrates which can be dissolved in a solvent. In many cases it is desirable that the web and pouch formed therefrom is able to dissolve in water or in an aqueous medium but dissolution in other solvents can be envisaged if the pouch is required to dissolve in a solvent other than water.

As used herein the term “water soluble” refers to material that are capable of being dissolved in water of whatever temperature to form a homogenous solution and the term “water dispersible” refers to materials that are capable of being dispersed in water of whatever temperature to form a permanent or temporary suspension. For convenience, where the term “water soluble” is used hereinafter in the description and claims, it will be understood that this includes “water dispersible”.

As used herein, the term “mould” refers to a constituent part (containing one or more cavities) of a rotatable former, the part often being designed to be easily exchanged within the former in order to produce pouches having different fill volumes. The term “cavity” refers to that part of the mould into which a base web is drawn during a thermoforming operation, and the term “pocket” refers to an open container which is formed in a base web as a result of a thermoforming operation.

As used herein, the term “nozzle” refers to a device capable of adding a filler material to a pocket where the filler material can be any of a liquid filler, a gel filler, a powder filler, a granular filler, a three-dimensional solid filler (tablet).

According to a first aspect of the invention there is provided a rotatable thermoforming machine for producing soluble pockets made from at least a first soluble web, the machine having a rotatable forming means comprising a plurality of pocket forming cavities in each of which a respective pocket is formed in the soluble web, the pockets travelling in a machine direction defined as the X direction and wherein the machine has filling means arranged to at least partially fill the or each pocket formed in the soluble web, the filling means comprising one or more nozzles, each nozzle being arranged to be moveable in at least the X-direction as the or each respective pocket is filled from the filling nozzle.

Preferably the or each nozzle is arranged to be movable in the X-direction, and a direction transverse to the X-direction defined as the Y-direction, or a combination of the X and Y directions as the respective pocket is being filled from the filling nozzle.

Preferably the or each nozzle is further adapted to be moveable in a direction at an angle to the machine direction. Desirably the or each nozzle may be arranged to be moveable in a direction at an angle of greater than 0° relative to the machine direction. The nozzles may be movable at an angle to the X direction as the nozzles fill the pockets. It will be appreciated that when the or each nozzle is moving at 0° to the direction of travel the nozzle is moving in or parallel to the direction of travel and in the X-direction. As the or each nozzle moves at an angle to the X-direction the or each nozzle may be moving in the Y-direction or in a combination of the X and Y directions.

In a preferred embodiment, the or each nozzle is arranged to follow a predetermined path. The predetermined path may be in the direction of travel of the pockets or at an angle thereto. The angle may be perpendicular to the direction of travel of the machine. The angle may be greater than 0° relative to the direction of travel of the rotatable forming means. The predetermined path may be in the direction of travel of the rotatable means or may be contrary or partially contrary to the direction of travel of the forming means. The predetermined direction may be transverse i.e. at 90° or 270° to the direction of travel or at another angle to the direction of travel of the pockets. The predetermined direction may be a combination of travel in the direction of travel of the rotatable forming means, transverse to the direction of travel or at an angle thereto, or contrary to or partially contrary to the direction of travel of the pockets of the soluble web. In some embodiments, the predetermined path may be controlled such that the nozzle is stationary for a period of time during the filling operation.

Preferably the rotatable forming means comprises one of a rotatable drum and a rotatable endless belt. In a preferred embodiment, the rotatable forming means comprises a rotatable drum. The machine may comprise a continuous motion rotatable thermoforming machine or an intermittent motion rotatable thermoforming machine.

In some embodiments a second web may be applied to the pocket. The second web may be applied to partially close the pocket or to separate a first filled component from another filled component.

In a preferred embodiment the pockets may be closed or lidded with a lidding web to form a pouch. Preferably the lidding web comprises a soluble polymeric substrate. In a preferred embodiment the webs are soluble in water or in an aqueous medium.

The second web may be an intermediate web. More than one intermediate web may be used in some embodiments.

For some pocket designs, it may be sufficient for the nozzle to move in the direction of travel of the rotatable forming means. In embodiments filling pockets that extend longitudinally it may be suitable for the nozzle to move in the machine direction and movement of the nozzle at a different angle to the machine direction may not be required.

In some cases the pocket may not have an axis. An example of such a case is a circular annular compartment. The filling nozzles are preferably arranged to travel in both the machine direction and in a direction at another angle to the machine direction, so, for example, the filling nozzle travels around part or all of the circular annular compartment.

In many cases, a pocket or compartment may have an axis. The term “axis of the compartment” in this context may be defined as the line of longest linear dimension dividing a plan view of the compartment or pocket into two equal areas. Where the plan view of the compartment or pocket is divided not just into two equal areas but into two areas of equal shape, the compartment may be defined as being symmetrical about its axis.

An advantage of the first aspect of the invention is that the or each nozzle is moveable in at least the X-direction which is the direction of travel of the pockets. Where the axis of the compartment lies parallel to the machine direction, the length of time available for filling the compartment or pocket will be greater than if the nozzle were fixed as in a conventional thermoforming machine, due to the or each nozzle travelling with the pocket in the X-direction. Accordingly the or each nozzle is in register with the pocket for a longer period of time so allowing filling of the pocket to be completed.

In an example where the axis of the compartment lies perpendicular to the machine direction, the length of time available for filling the pocket or compartment will be shorter than in a conventional intermittent motion thermoforming machine. It will be appreciated that as the nozzle travels along the compartment in the predetermined direction then the length of time available for filling the pocket will be increased. It will be appreciated that where the axis of the compartment lies either parallel to, or perpendicular to the machine direction, or at an angle therebetween, then the length of time available for filling the pocket or compartment when the or each nozzle is fixed relative to the direction of movement of travel of the rotatable forming means, will be proportional to the linear dimension of the compartment in the machine direction under the filling nozzle.

Desirably the predetermined direction moves the nozzle in at least the direction of travel of the rotatable forming means so that the nozzle remains in register with the pocket for a longer period of time so increasing the length of time available for filling the pocket or compartment. This is particularly advantageous with rotatable thermoforming machines as the pockets can only be filled in a certain section of the rotation in order to avoid the filled component from falling out of the pockets as the former continues to rotate. It will be appreciated that the pocket has to be closed before the rotation of the former is sufficient to cause the filled component to be at risk of falling out of the pocket.

Preferably the predetermined path is controlled to move the nozzle in register with the pocket as the rotatable forming means advances. Preferably the predetermined path may be controlled to move at an angle to the direction of travel of the rotatable forming means.

In prior art examples it will be appreciated that filling the required amount of powder, granules or liquid within the short time available becomes more difficult where the compartment is “awkward” to fill. In describing this invention, we define an “awkward shaped compartment” as one which is unsymmetrical about its axis or having an axis neither parallel to, nor perpendicular to, the machine direction, or a peripheral “race track shaped” compartment. An S-shaped compartment would be an example of an awkward shaped compartment.

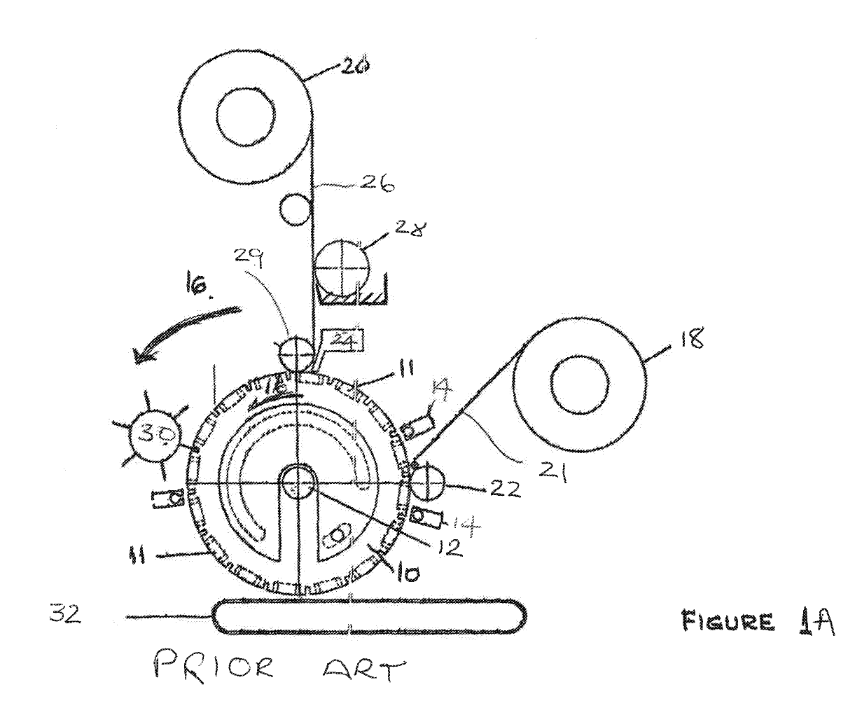

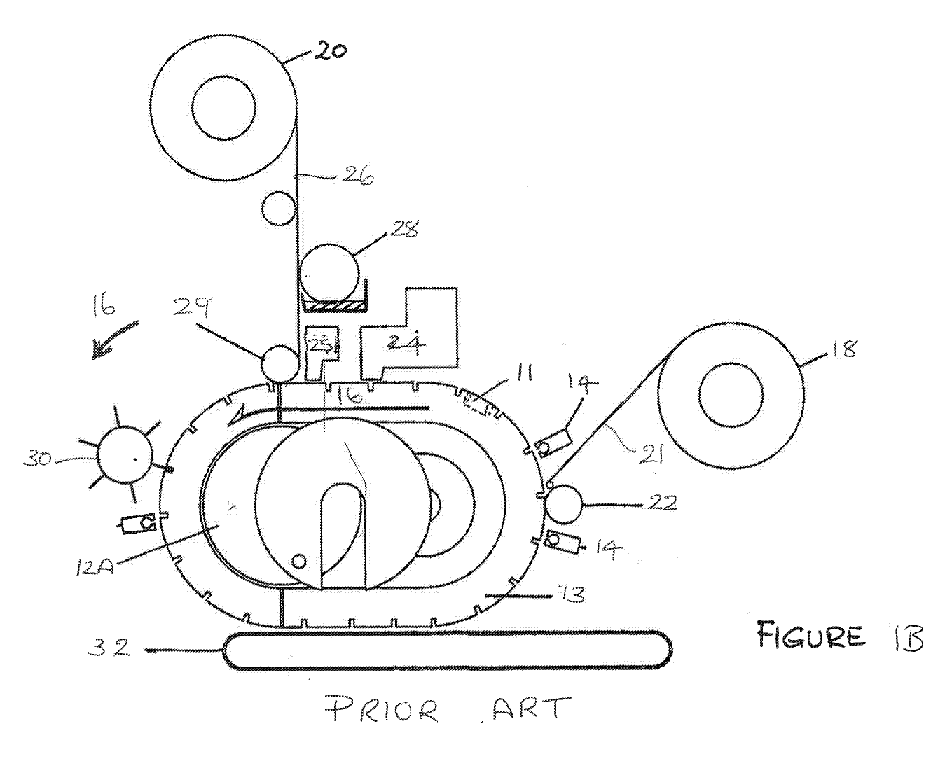

In an example the axis of the compartment may lie at 45 degrees to the machine direction. Such a compartment is illustrated in FIG. 1 of the accompanying drawings. Filling such a compartment is made more difficult for two reasons. Firstly, the viscosity of a liquid, gel or paste or the flow characteristic of a powder or granular composition may prevent the filled material from distributing itself substantially uniformly within the pocket or compartment within the time available. Secondly, the time available for filling will be proportional to the linear dimension of a line through the cavity or compartment in the direction of travel of the pockets where such line passes through the centre of the filling nozzle. In a case where the axis of the compartment lies at 45 degrees to the machine direction, the time available for filling the compartment from a fixed or stationary nozzle may be reduced by 75% when compared to a compartment of similar dimensions wherein the axis of the similar compartment lies parallel to the machine direction.

The present invention overcomes the difficulties described above by allowing the filling nozzle to move in a prescribed movement in at least the direction of travel of the pockets or in transverse direction relative to the direction of travel or more often, in a direction that has a component of travel in both parallel and transverse directions at the same time, thereby providing freedom to optimise the filling process. Desirably the filling nozzle can also be made to travel in any predetermined path that is required to optimise the filling process, for example, but not limited to, when filling an annular compartment, an S-shaped compartment, a U-shaped compartment, or a zig-zag shaped compartment, or a curved compartment and a non-linear shaped compartment.

The movement of the or each filling nozzle or a group of filling nozzles may be driven, for example, by a linear servomotor, a servo with a rack and pinion drive, an air cylinder, or a magnetic device providing two electrically activated magnets for X and Y movement, or combinations thereof. The movement itself can be translated by a slide or a robotic arm motion, a mechanical assembly, or a combination thereof.

In a typical continuous motion thermoforming machine there may be one or more tracks. Preferably, the machine may comprise a plurality of tracks along a length of the former. Preferably there may be up to 50 tracks or more preferably up to 20 tracks. Preferably there may be at least 5 tracks. Each of the tracks are preferably parallel to one another. A series of pocket forming cavities may be provided in each track.

In a preferred embodiment a row of a plurality of nozzles may be provided corresponding to the plurality of tracks. The plurality of nozzles in the row may be mounted in a manifold. Desirably each nozzle in the row of nozzles may be arranged to move in synchronicity. The synchronous movement may be controlled by movement of the manifold. The nozzles are preferably connected to a filling chamber and thence to a hopper. A connection from each filling chamber to the hopper is preferably flexible.

In some embodiments the or each pocket is arranged to form a multi-compartment pouch. In some embodiments a group of filling nozzles may be arranged to fill different compartments of a multi-compartment pouch. The compartments may be the same or different. In some cases the filling nozzle of each compartment of a multi-compartment pouch may be moved in a different predetermined path. In some embodiments it is desirable to arrange the nozzles to follow separate paths in order to fill non-identical compartments. Alternatively the whole filling nozzle assembly or manifold may be moved synchronously such that each filling nozzle moves in an identical parallel path. It will be appreciated the machine may comprise one or more rows of filling means. Each filling means may comprise a group of two or more filling nozzles arranged to be able to fill corresponding compartments in a multi compartment pouch.

In some embodiments the shape of the filling nozzle opening can be modified to achieve an extended filling time, by means of, for example, providing a nozzle opening having a shape wherein the long axis is parallel to the axis of the cavity being filled. The shape may be slotted. Alternative nozzle openings may be provided which have an opening axis which is in line with the direction of travel of the rotatable former. In an alternative arrangement the cavity may have an axis that is at an angle to the direction of travel of the rotatable former and an axis of the nozzle opening may be in line with the axis of the cavity.

In accordance with another aspect of the invention there is provided a thermoforming machine having one or more filling nozzles wherein the filling nozzles are arranged to be able to move along the axis of at least one compartment of the machine during filling of the compartment.

The thermoforming machine may be a continuous motion rotatable thermoforming machine or an intermittent rotatable thermoforming machine. Desirably the one or more filling nozzles are able to move along the axis of at least one compartment of a multi-compartment pocket during the filling of the at least one compartment. Desirably the or each filling nozzle is arranged to move in at least the direction of travel of the pockets defined as the X direction. Preferably the or each filling nozzle is arranged to be able to travel at an angle greater than 0° relative to the X-direction. Desirably the angle is less than 360°.

In accordance with another aspect of the invention there is provided a multi-compartment pouch comprising two or more compartments, formed from two or more substrates wherein the or each substrate is water-soluble or water-dispersible, wherein at least one compartment comprises more than one component.

In another aspect of the present invention, a multi-compartment pouch is provided formed from two or more water-soluble or water-dispersible polymeric substrates wherein at least one compartment has an axis which is not parallel to machine direction. Further examples of awkward multi-compartment pouches formed from two or more water-soluble or water-dispersible polymeric substrates are those wherein at least one compartment has a one of a zig-zag shaped compartment, a U-shaped compartment, or an S-shaped compartment or the compartment has a non-linear shape.

In another aspect of the invention, a multi-compartment pouch is provided formed from two or more water-soluble or water-dispersible substrates, comprising at least one compartment which, by means of movable filling nozzles or otherwise, comprises more than one component.

The more than one components may either be selected to mix within the compartment or may be selected so as not to mix within the compartment. An example of components that may be selected so as not to mix include a gel and a powder or granules where the powder or granules is added after the gel. Intermediate webs may be applied to the pocket to separate components. A lidding web may be applied to close the pocket and form a pouch.

In one embodiment of the invention the compartment may first be filled with a molten liquid at a temperature of up to 150° C. (302° F.) and then a second component may be filled on top of the first component, once at least the upper surface of the first component has cooled sufficiently for it to become solid. Sufficient cooling may be achieved by means of lower machine speed or by providing sufficient cooling, such that at least the upper surface of the first component becomes solid in time for the second component to be filled at a second filling station positioned later in the movement of the machine.

In an alternative embodiment in which the two components are segregated within a compartment of a multi-compartment pouch, a three dimensional pre-formed solid component such as a tablet may be inserted as the second component. The pre-formed solid component or tablet may be coated with a soluble polymer or a mixture of several soluble polymers in order to vary the time at which the material comprising the tablet is released into an aqueous environment into which the multi-compartment pouch has been placed.

Desirably it can be arranged that the solidified liquid or the preformed solid component has a longer dissolution time than the other components within the pouch thus providing a sequential release pattern of the components once the pouch is introduced into an aqueous environment. It will be appreciated that alternative arrangements can be readily envisaged by the skilled person and the above examples of segregated components within at least one compartment of a multi-compartment pouch are illustrative only and should not be considered limiting.

According to another aspect of the invention there is provided a method of filling a water soluble pouch comprising at least one water-soluble substrate web the method comprising:
providing a rotatable forming means having a plurality of pocket forming cavities, the pocket forming cavities travelling in a machine direction defined as an X direction;
forming the web into the cavities to provide a pocket;
bringing a filling means into register with one or more of the pockets;
filling the or each pocket with at least one component;
wherein the or each filling means moves in at least the machine direction as the or each respective pocket is filled from the filling means.

Preferably the filling means comprises at least one nozzle. Desirably the filling means comprises a plurality of nozzles. The or each nozzle is moveable in at least the X-direction as the pockets are filled. The filling means may comprise a row of nozzles arranged to correspond to a series of tracks of pocket forming cavities on the former. In a preferred embodiment the or each row of nozzles may be arranged to move in synchronicity. The or each row may be connected to a manifold.

The filling means may comprise a group of nozzles arranged to fill a number of compartments in a multi-compartment pocket. The compartments may be the same or different. Each nozzle in the group of nozzles filling the different compartments of a water-soluble pouch may be arranged to move independently of the other nozzles in the group. Each nozzle may have a different pre-determined path. The predetermined path of each nozzle may be dependent on the shape of the respective compartment of the multi-compartment pouch.

Desirably movement of the or each filling nozzle, row of filling nozzles or a group of filling nozzles may be driven, for example, by a linear servomotor, a servo with a rack and pinion drive, an air cylinder, or a magnetic device providing two electrically activated magnets for X and Y movement, or combinations thereof. The movement itself can be translated by a slide or a robotic arm motion, a mechanical assembly, or a combination thereof. Other means of controlling the movement of the or each filling nozzle, row of filling nozzles or group of nozzles may be envisaged by the skilled person.

Desirably the filling nozzle is arranged to move in register with the or each pocket or compartment of the pocket until the filling is completed.

The or each filling nozzle may be arranged to move in the machine direction and at least partially in a direction at an angle to the machine direction. Preferably the or each nozzle follows a predetermined path which is desirably selected to optimise filling of the or each respective pocket. The nozzles may be arranged to follow an axis of the or each compartment.

Desirably the or each nozzle is arranged to move in a predetermined path as the or each respective pocket is being filled. The predetermined direction may in the X-direction or at an angle thereto. The angle may be greater than 0° relative to the X-direction. In some embodiments the angle may be transverse to the direction of travel of the machine. The predetermined path may be a combination of travel in the X-direction or transverse to the X-direction defined as a Y-direction or in a combination of movement in the X and Y directions. In some embodiments the predetermined path may be controlled such that the nozzle is momentarily stationary for a period of time and the pockets move past the nozzle such that the nozzle follows a predetermined path contrary to the direction of movement of the pockets.

A control means may control the direction followed by the or each filling nozzle as it is moved to follow the predetermined path. The control means may be a computer and may be provided remote from the machine.

It will be appreciated that this aspect of the present invention can equally well be practised with continuous motion forming machines and with intermittent motion forming machines

According to another aspect of the invention there is provided a pouch formed by the inventive method set out above.

Desirably the pouch is formed from two or more water-soluble or water-dispersible polymeric substrates wherein the pouch comprises at least one compartment having an axis which is not parallel to machine direction.

In a preferred embodiment the pouch comprises two or more compartments, formed from two or more substrates wherein the or each substrate is water-soluble or water-dispersible. In some embodiments at least one compartment comprises more than one component.

In some embodiments pouches formed from two or more water-soluble or water-dispersible polymeric substrates comprise at least one compartment having one of a zig-zag shaped compartment, a U-shaped compartment, or an S-shaped compartment or a compartment having a non-linear axis.

According to another aspect of the invention there is provided a former arranged to move in a machine direction defined as the X-direction and a filling nozzle arranged to fill a compartment of a pocket in a cavity in the former wherein the filling nozzle moves in at least one of the X direction, a direction transverse to the machine direction defined as the Y-direction, or a combination of the X and Y directions as the compartment is filled.

It will be appreciated that this aspect of the present invention can equally well be practised with continuous motion forming machines and with intermittent motion forming machines. Movement of the filling nozzle as the compartment is filled may improve filling of an awkward shaped compartment particularly those being filled with less free flowing materials such as viscous gels and pastes, powders and granules.

The invention will now be described by way of example only with reference to the accompanying figures in which:

FIG. 1A is a schematic side view a prior art continuous motion rotatable thermoforming machine comprising a rotatable drum former;

FIG. 1B is a schematic side view of a prior art continuous motion rotatable thermoforming machine comprising an endless belt rotatable former;

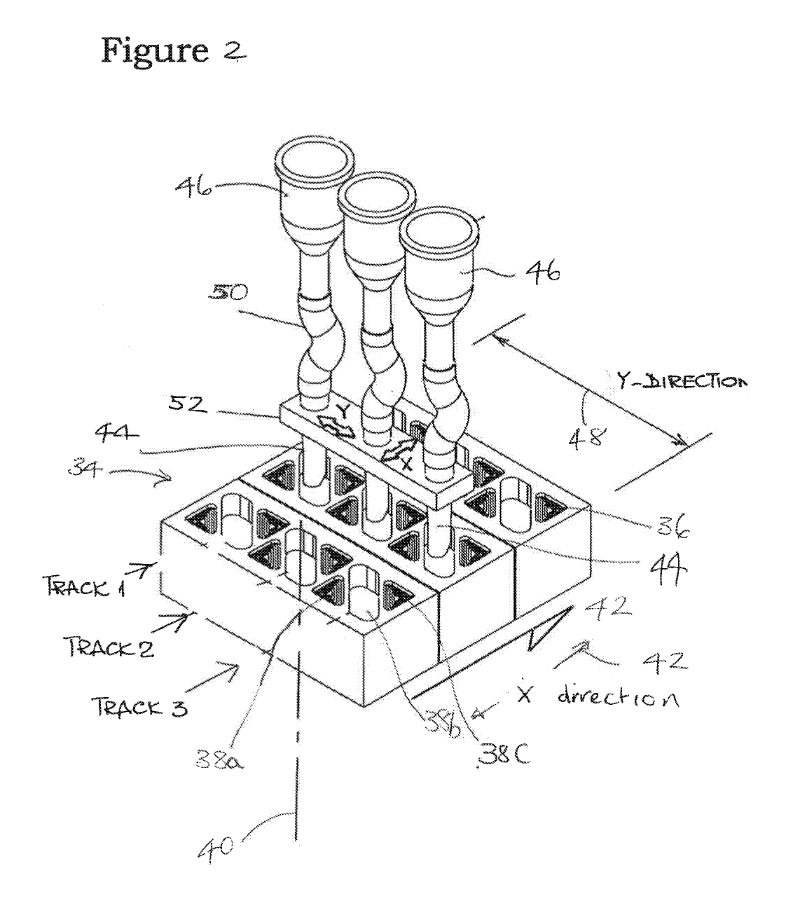

FIG. 2 illustrates a section of rotatable former in accordance with the invention in which each pouch formed has three compartments;

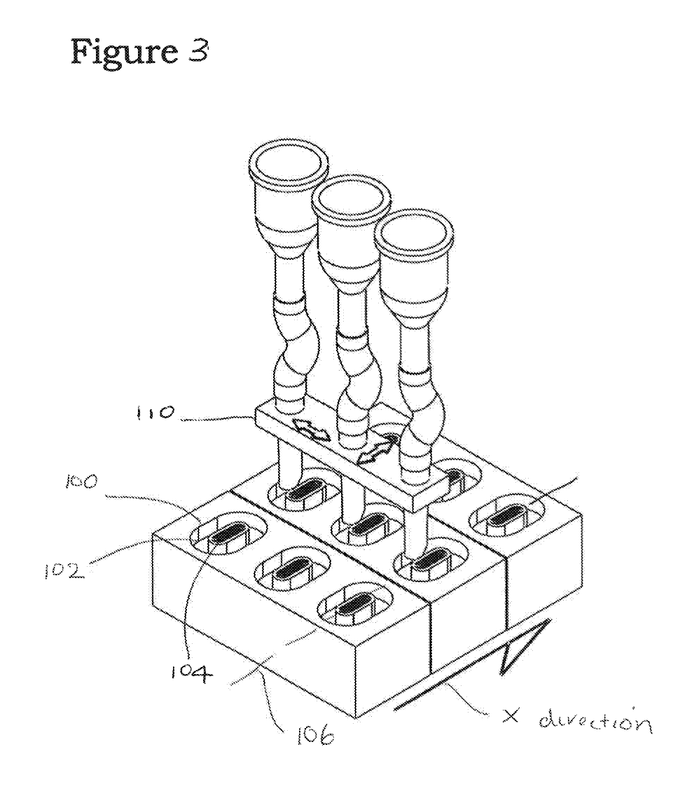

FIG. 3 illustrates another section of a rotatable former in accordance with the invention in which each pouch has two compartments one of which is a peripheral “race-track” compartment;

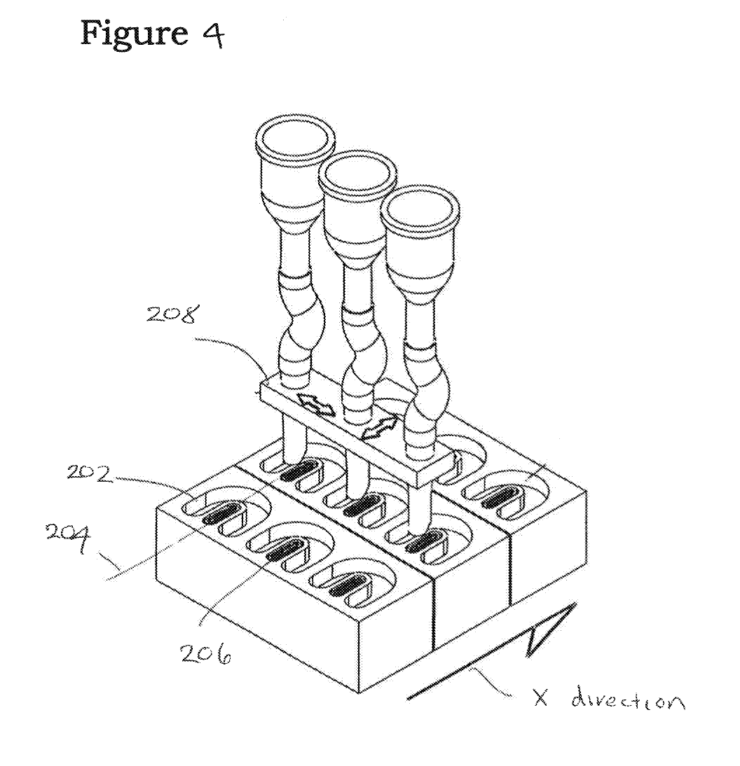

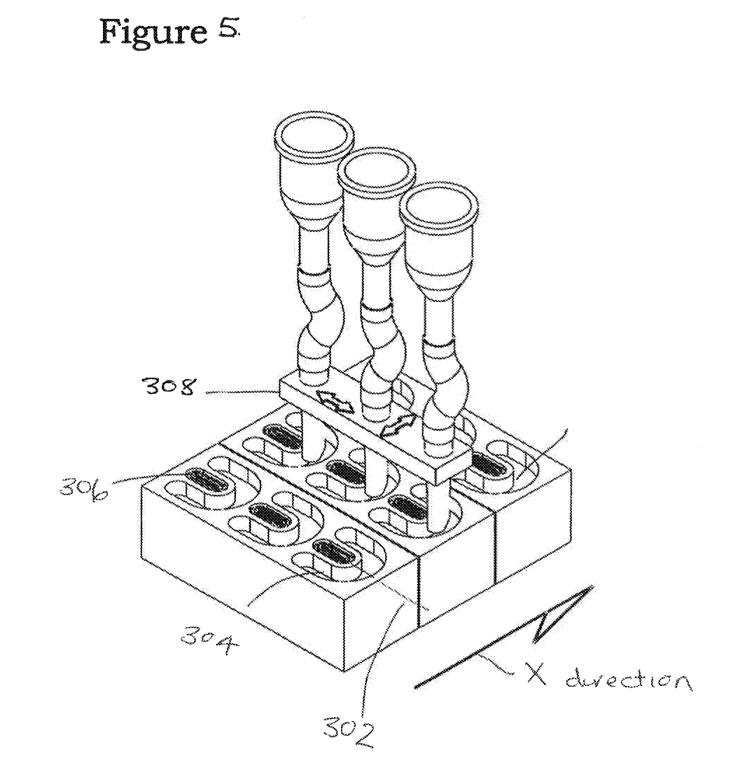

FIG. 4 illustrates a former in accordance with the invention in which each pouch has two compartments one of which is U-shaped;

FIG. 5 illustrates a modification of the former of FIG. 4 in which an axis of the U shaped compartment is transverse to a direction of travel of the former;

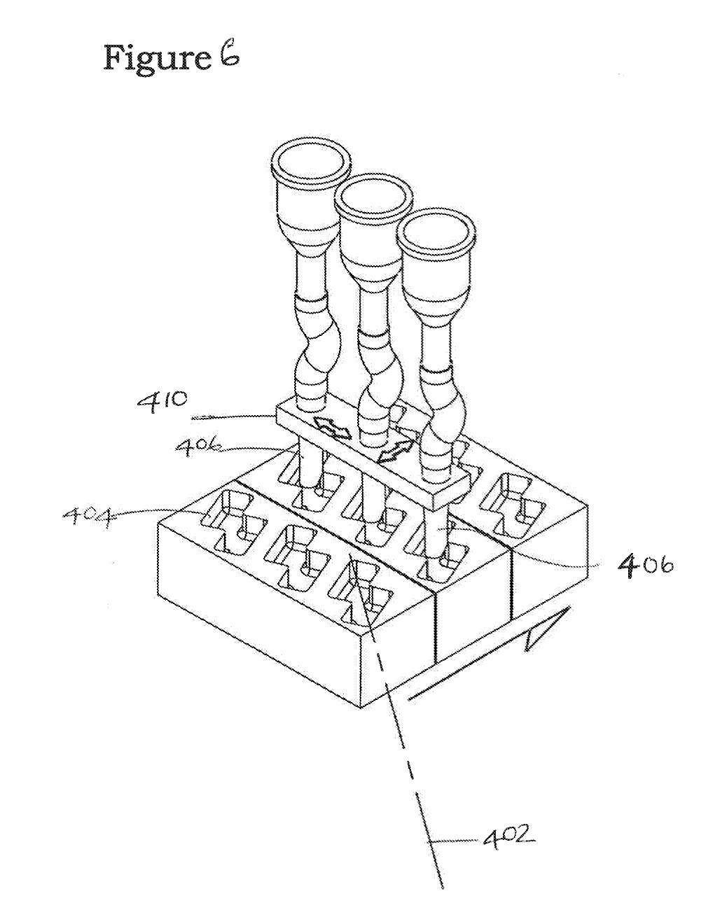

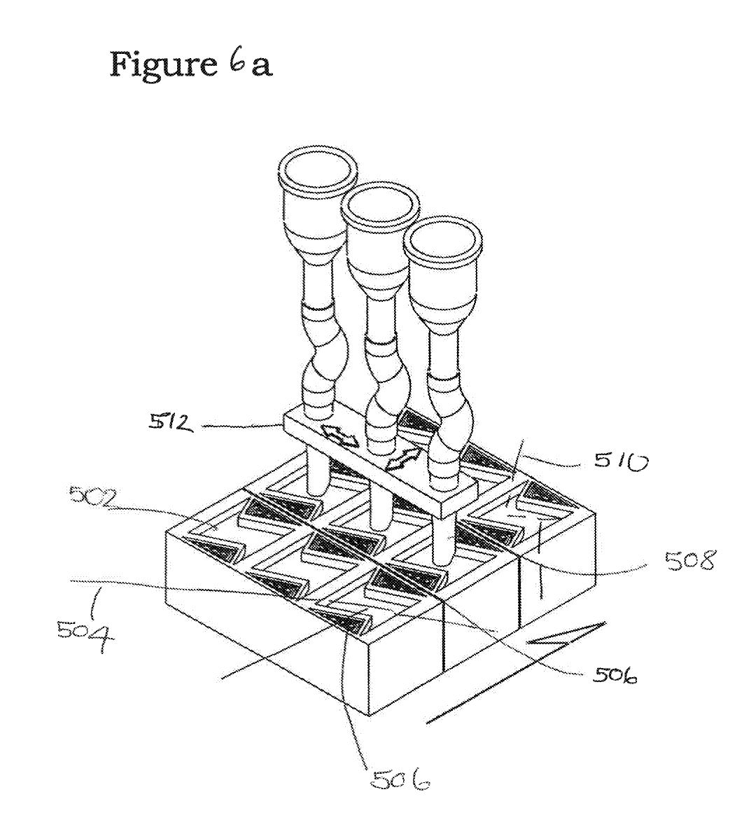

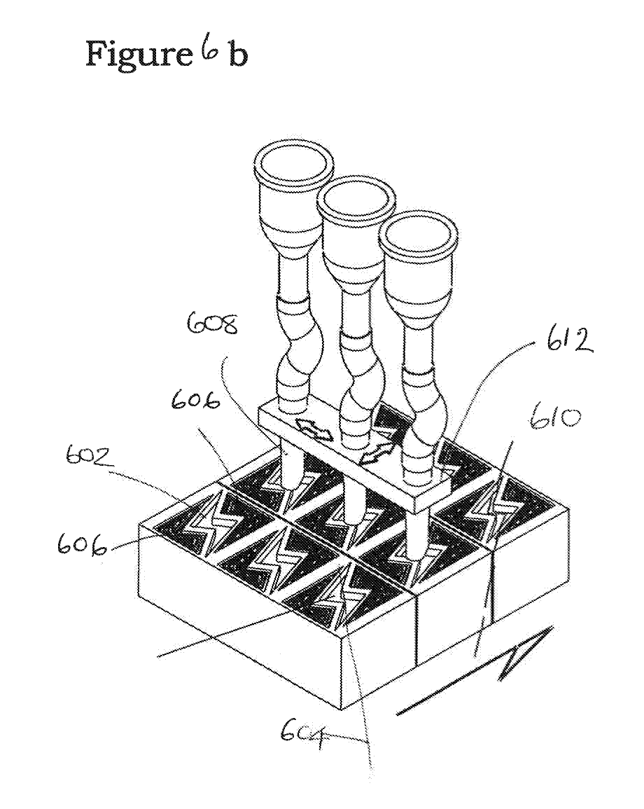

FIGS. 6, 6a and 6b illustrate a further modification, each compartment having a zig-zag form; and

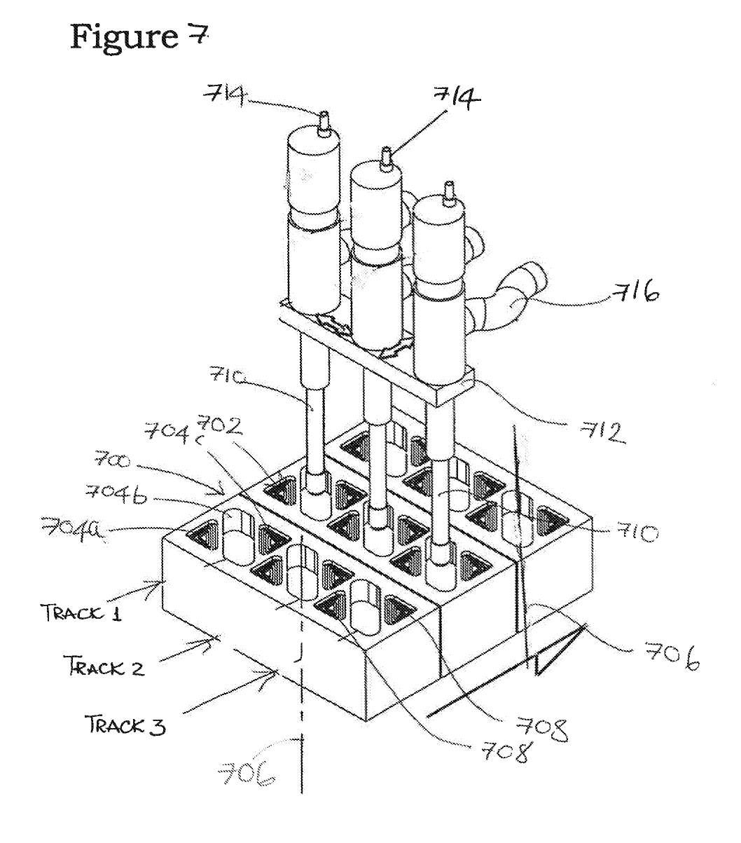

FIG. 7 illustrates a modified former in which each pouch is arranged to have three compartments;

FIG. 1A illustrates a schematic view of a prior art continuous motion former comprising a rotatable drum. The former employs a drum 10 with cavities 11. The drum is continuously rotated by any suitable means such as a motor via a drive shaft 12. Preferably the motor is electric and it is preferred that the motor is a variable speed motor. The drum 10 is heated and cavities 11 are additionally heated by different means. In the illustrated embodiment externally mounted hot air heaters 14 are employed and electrical heaters may be located within the drum.

The drum 10 is rotated in the direction indicated by arrow 16. This is the machine direction. Soluble pouches are formed from two webs that are drawn respectively from rolls 18 and 20. The webs typically comprise soluble polymer substrates such a water soluble films which may dissolve at the same temperature. The first (base) web 21 from roll 18 is guided around a heated roller 22 which presses it tightly over cavities 11 located around the circumference of the drum into which the base web 21 is drawn by suction from within the drum 10, thus forming pockets in the base web 21. The surface temperature within the cavities 11 and the temperature of the heated roller 22 will depend of the type of film, its thickness and the speed of rotation of the drum. Desirably the surface temperature within the cavities is at least 60° C. and may be up to 160° C. The surface of the drum surrounding the cavities should be smooth and preferably polished. The pockets move with the former in the direction of rotation and the direction of movement of the pockets is defined as the X-direction. The pockets of film are filled at the top of the drum 10 from a first filling hopper or injector 24 and in the case of a granular or powder product the fill may be smoothed by wipers (not shown) which also clean product from the upper surface of the base web 21 surrounding the pockets. A top or lidding web 26 from roll 20 is made adhesive by moistening the sealing surface to a sufficient extent by means of a felt roller 28 rotating within a bath of liquid in which the top web 26 is soluble. It is important that the amount of liquid applied to the sealing surface of the top web 26 is controlled very accurately. If too much liquid is applied the water soluble film forming the top web 26 will be weakened and in the limit, even dissolved. The top web 26 and base web 21 are then pressed together as the top web 26 passes beneath a heated roller 29 which is elastically pressed by a spring (not shown) against the surfaces of the drum 10 surrounding the cavities to form a pouch between the pockets of base web 21 and the top web 26 such that the periphery around the filled pouches is securely sealed by a combination of heat and solvent welding. While still held in the respective cavities by the vacuum within the drum, the sealed pouches are then separated from each other by means of transverse knives 30 and longitudinal knives (not shown) after which they are ejected by means of an air blow-off and fall onto the conveyor belt 32.

It will be appreciated that the pockets have to be filled while they are at the top of the rotatable former. The lidding web also has to be applied while the pockets are at the top of the former or the filled component may escape from the pocket as the former rotates.

An alternative prior art continuous motion former is schematically illustrative in FIG. 1B. The former of FIG. 1B differs from that of FIG. 1A in that the former employs a rotating endless belt 13 having cavities 11. Other features are typically the same and the same reference numerals have been used for corresponding features. The embodiment having an endless belt is briefly described. The belt 13 is continuously rotated by any suitable means such as a motor via a gear wheel 12A. Preferably the motor is electric and it is preferred that the motor is a variable speed motor. As with the rotatable drum the belt 13 is heated and cavities 11 are additionally heated by different means. In the illustrated embodiment externally mounted hot air heaters 14 are employed and electrical heaters may be located within the belt and arranged to heat the cavities.

The belt 13 is rotated in the direction indicated by arrow 16. This is the machine direction. Soluble pouches are formed from two webs that are drawn respectively from rolls 18 and 20. The webs typically comprise soluble polymer substrates such a water soluble films which may dissolve at the same temperature. The first (base) web 21 from roll 18 is guided around a heated roller 22 which presses it tightly over cavities 11 located around the belt into which the film is drawn by suction from within the belt 13, thus forming pockets of film in the cavities. The surface temperature within the cavities 11 and the temperature of the heated roller 22 will depend of the type of film, its thickness and the speed of rotation of the belt. Desirably the surface temperature within the cavities is at least 60° C. The surface of the belt surrounding the cavities should be smooth and preferably polished. The pockets move with the former in the direction of rotation and, as in the embodiment of FIG. 1A, the direction of movement of the pockets is defined as the X-direction. In this arrangement the former is provided with two filling equipments. The pockets are filled at the top of the belt 13 from a first filling hopper or injector 24 and from a second filling hopper 25. In some embodiments further filling hoppers may be provided. The first and second filling hoppers may be arranged to fill the pockets with different components such as tablets, gels, liquids or powders. A separating web (not illustrated) can be applied to the pockets between the first and the second components. A closing or lidding web 26 from roll 20 is made adhesive by moistening to a sufficient extent by means of a felt roller 28 rotating within a bath of liquid in which the top web is soluble. As before it is important that the amount of liquid applied to the surface of the top web is controlled very accurately. The top web and base web are then pressed together as the top web passes beneath a heated roller 29 and the periphery around the filled pouches is securely sealed by a combination of heat and solvent welding. While still held in the respective cavities by the vacuum within the drum, the sealed pouches are then separated from each other by means of transverse knives 30 and longitudinal knives (not shown) after which they are ejected by means of an air blow-off and fall onto the conveyor belt 32.

It will be appreciated that the pockets have to be filled while they are at the top of the rotatable former. The endless belt 13 illustrated in side elevation has an almost elliptical path which contain horizontal sections providing the forming surface. The forming surface is substantially horizontal along the upper portion of the belt so providing greater space and more time for filling and sealing of pouches, particularly multicomponent pouches. As before the lidding web has to be applied while the pockets are at the top of the former or the filled component or components may escape from the pocket as the belt rotates from the horizontal.

FIG. 2 illustrates a section of a rotatable former 34 in a machine in accordance with an embodiment of the invention. For ease of description the former is illustrated with three tracks but it will be appreciated that the number of tracks may be selected to be from 1 to 20 or more. In each track there are a series of pocket forming cavities arranged to form pouches in use. In the illustrated example each pouch 36 has three compartments 38a, 38b, 38c, one of which has an axis 40 which is not parallel to the direction of motion of the pockets—the X-direction. The section of the former 34 is moving in a X-direction 42. The shaded compartments 38a and 38c have been filled in a prior operation by appropriate means. In order to fill the compartment 38b which has an axis 40 which is not parallel to the machine direction 42 with for example, a granular or powder composition, three filling nozzles 44 are provided, one for each track (track 1, track 2, track 3), each filling nozzle is connected to a respective filler 46 which is connected to the hopper 24.

Each of the three filling nozzles 44 is arranged to be able to move in a path comprising an X-direction or a Y-direction or a combination of X and Y directions such that the filling of the respective compartment in able to be completed satisfactorily within the available time interval. The X and Y directions are schematically indicated in FIG. 2. The X direction 42 is parallel to the machine direction 16. The Y direction 48 is transverse to the X-direction. The Y direction is one of 90° or 270° to the X-direction.

Each of the three filling nozzles are arranged to be moved along a predetermined path that is at another angle to the machine direction 16 and this another angle is a combination of X and Y direction movements such that the nozzles move at an angle that is greater than 0° relative to the X-direction 16. The predetermined path is controlled by a controller directing the movement of the nozzles in the X and Y direction (42, 48) to follow the predetermined path.

In the example of FIG. 2 the axis 40 of the compartment 38b is at substantially 45° relative to the direction of travel of the machine in the X direction. The filler nozzles 44 are arranged to start filling at one end of the compartment 38b and to move in a direction from 135° relative to the X direction towards 315° relative to the X direction.

In this embodiment each filler nozzle 46 has a flexible coupling 50 between the nozzle and the filler nozzle.

It is convenient for the filling nozzles to be mounted on a manifold 52 so that by moving the manifold, each filling nozzle is able to follow an identical path. Each coupling passes through a manifold 52 coupling the nozzles together such that the movement of each nozzle is the same. The manifold 52 ensures that the nozzles move in synchronicity. It is envisaged that each nozzle could be controlled individually if desired.

FIG. 3 illustrates the same type of rotatable former, but in this figure, each pouch 100 comprises two compartments, one of which is a peripheral “race track” compartment 102. The second compartment 104 is encircled by the first compartment. Other than the configuration of the compartments, the rest of the machine is the same as that described in relation to FIG. 2 and will not be described again.

The second compartment has an axis 106 which is parallel to the X direction. The first compartment 104 has an annular shaped form which surrounds the second compartment 104. The shaded compartments 104 have been filled in a prior operation by appropriate means. Although the peripheral race track compartment 102 has an axis parallel to the or X-direction, it is necessary to provide a filling nozzle which is able to move in a combination of X and Y directions along a path which follows the line of the peripheral race track compartment and therefore able to fill said compartment satisfactorily within the time interval available with for example, a granular or powder composition. Again, it is convenient for the filling nozzles to be mounted on a manifold 110 so that by moving the manifold, each filling nozzle is able to follow the line of the peripheral race track compartment and to stay in register with the compartment so lengthening significantly the time interval available to complete the filling of the compartment. In this embodiment the manifold 110 moves the nozzle heads around in the X and Y directions to move the nozzle head around the race track form of the compartment. The nozzles initially move in a transverse direction (270°) across a first section of the compartment and then in the X direction (0°) along one side of the track. The nozzles then move in the transverse direction (90°) across the track. The nozzles may be arranged to move in the direction contrary to the X direction (i.e. at 180°) relative to the X direction or may be arranged to be stationary such that the compartment moves relatively in the X direction beneath the nozzle.

FIG. 4 illustrates the same rotatable former but, in this figure, the shape of the compartments has been changed. In this embodiment the peripheral race track compartment 202 is incomplete, resulting in a U-shaped compartment which has an axis 204 parallel to the X-direction. The shaded compartments 206 have been filled in a prior operation by appropriate means. Although the U-shaped compartment has an axis parallel to the X-direction, it is necessary to provide a filling nozzle which is able to move in a combination of X and Y directions along a path which follows the line of the U-shaped compartment and therefore able to fill said compartment satisfactorily within the time interval available with for example, a granular or powder composition. Again, it is convenient for the filling nozzles to be mounted on a manifold 208 so that by moving the manifold 208, each filling nozzle is able to follow the line of the U-shaped compartment.

FIG. 5 illustrates the same rotatable former but, in this figure, the axis 302 of the U-shaped compartment 304 lies in a transverse direction (or Y-direction) relative to the X-direction. The shaded compartments 306 have been filled in a prior operation by appropriate means. Although the U-shaped compartment 304 has an axis 302 transverse to the machine direction, it is necessary, as in FIG. 4, to provide a filling nozzle which is able to move in a combination of X and Y directions along a path which follows the line of the U-shaped compartment and therefore able to fill said compartment satisfactorily within the time interval available with for example, a granular or powder composition. Again, it is convenient for the filling nozzles to be mounted on a manifold 308 so that by moving the manifold 308, each filling nozzle is able to follow the line of the U-shaped compartment 304.

FIG. 6 illustrates the same rotatable former but, in this figure, the axis 402 of the single compartment 404 is neither parallel to the X-direction nor to the transverse direction or Y-direction. It is necessary to provide a filling nozzle 406 which is able to move in a combination of X and Y directions along a predetermined path which broadly follows the axis 402 of the compartment 404 and therefore able to fill said compartment 404 satisfactorily within the time interval available with for example, a granular or powder composition. Again, it is convenient for the filling nozzles 406 to be mounted on a manifold 410 so that by moving the manifold 410, each filling nozzle 406 is able to follow the axis of said compartment 404.

In FIGS. 6a and 6b, we illustrate two examples of “zig-zag” compartments, 502 and 602 respectively, whose axes 504 and 604 do not lie parallel to the machine direction, the X-direction. The shaded compartments 506 and 606 have been filled in a prior operation by appropriate means. It is necessary to provide a filling nozzle 508 and 608 which is able to move in a combination of X and Y directions along a path 510 and 610 (in the examples illustrated in these two figures a zig-zag path), which broadly follows a zig-zag path and therefore able to fill said compartment satisfactorily within the time interval available with for example, a granular or powder composition. Again, it is convenient for the filling nozzles to be mounted on a manifold 512 and 612 so that by moving the manifold 512 or 612, each filling nozzle 508 or 608 is able to follow the axis of said compartment.

FIG. 7 illustrates an alternative three track rotatable former 700 in which each pouch 702 has three compartments 704a, 704b, 704c, one of which has an axis 706 which is not parallel to the machine direction (or X-direction). The shaded compartments 708 have been filled in a prior operation by appropriate means. In order to fill the compartment 704b which has an axis 706 which is not parallel to the machine direction with a gel or paste composition that does not flow naturally, three filling nozzles 710 are provided, one for each track, wherein each of the three filling nozzles 710 is able to move in a path comprising an X-direction or a Y-direction or a combination of X and Y directions such that the filling of said compartment in able to be completed satisfactorily within the available time interval. It is convenient for the filling nozzles 710 to be mounted on a manifold 712 so that by moving the manifold 712, each filling nozzle 710 is able to follow an identical path. The filling nozzles 710 are activated by timing air control which is delivered to actuators through timing air control nipples 714. In this example the filling nozzles 710 are rigid. A flexible coupling 716 is provided between the nozzles and the filler (not shown).

FIG. 7 should be taken to illustrate that filling a compartment with a gel or paste that does not flow naturally can be provided by the present invention in a similar manner as was provided when filling a similar compartment with a granular or powder composition in FIGS. 2, 3, 4, 5, 6, 6a and 6b; only the filling apparatus is different. In each of FIGS. 2, 3, 4, 5, 6, 6a, 6b and 7, a flexible coupling 720 is provided in order to deliver the composition to be filled to the moveable filling nozzles 716, whether a granular or powder composition in FIGS. 2, 3, 4, 5, 6, 6a, 6b, or a gel or paste composition that does not flow naturally in FIG. 7.

It will be understood that for ease of description the rows of nozzles have been shown with each nozzle filling a single compartment. It has been described that the other compartments have been filled in a separate step. The skilled person will appreciate that a group of nozzles may be provided suitably arranged to fill all of the compartments of a multi-compartment pouch simultaneously. The group of nozzles can be arranged to fill each of the compartments required to form a multi compartment pouch in one step. Each nozzle in the group can be controlled to follow a different predetermined path depending on the shape and orientation of the respective compartment.

The skilled person will appreciate that the inventive concept may be used with intermittent forming and filling processes where filling occurs whilst the web is stationary at a filling station on an endless belt. Improved filling speeds may be obtained due to movement of the filling means according to this invention whilst the web is stationary.

It will be appreciated that the described former can be used with existing methods to form multi-component pouches. In some cases the components should not mix as they may be potentially antagonistic. This may be achieved by for example, filling first a molten gel product, and then by providing cooling means to the upper surface of the gel such that it cools sufficiently to form a skin. A granular or powder product, or a liquid, gel or paste product may then subsequently be filled directly upon the solidified upper surface of the gel, such that the two products do not mix together. Alternatively, an intermediate web may be provided between the first and the second components such that the two components do not mix.

A multi-component pouch containing three different products can be filled such that the components do not mix and thereby become potentially antagonistic. In one example a three dimensional solid object, is inserted into a molten gel before the molten gel has formed a solid skin on its upper surface. In order to prevent chemical or physical interaction between the three dimensional solid object and the molten gel, the three dimensional solid object is coated, either in-line or off-line (using a separate process), with one or more water-soluble or water-dispersible polymers which may or may not be similar or identical to the material of either or both of the webs used to produce the pouch in order thereby to obtain sequential release of the components. The filling of the compartment is completed with a granular or powder product, or a liquid, gel or paste product, being filled upon the by now solidified upper surface of the molten gel.

Alternatively the filling of the pouch can be completed with a liquid or a second type of gel being filled upon the by now solidified upper surface of the molten gel.

As in known processes a single compartment of a multi-compartment pouch can be supplied using either stationary or rotating nozzles, with a multiple gel or paste fill, each gel or paste having a different composition, colour and/or appearance in order to create an attractive pattern within the pouch.

Single compartment and multi-compartment pouches may be formed from two, three or four webs on one or two forming machines such as described in our earlier patent applications WO2011/061628, WO2013/190517 and WO2014/170882 wherein the or each compartment can be filled using movable filling nozzles as described herein.

1. A rotatable thermoforming machine for producing soluble pockets made from at least a first soluble web, the machine having a rotatable forming means comprising a plurality of pocket forming cavities in each of which a respective pocket is formed in the soluble web, the pockets travelling in a machine direction defined as the X direction and wherein the machine has filling means arranged to at least partially fill the or each pocket formed in the soluble web, the filling means comprising one or more nozzles each nozzle being arranged to be moveable in at least the X-direction as the or each respective pocket is filled from the filling nozzle.

2. A rotatable thermoforming machine according to claim 1 wherein the or each nozzle is arranged to be movable in the X-direction, and a direction transverse to the X-direction defined as the Y-direction, or a combination of the X-and Y-directions as the respective pocket is filled from the filling nozzle.

3. A rotatable thermoforming machine according to claim 1 or claim 2 wherein the machine comprises a plurality of tracks of cavities and a corresponding plurality of rows of filling nozzles arranged to correspond with the pockets formed in the plurality of tracks of cavities and wherein each nozzle in a respective row moves in synchronicity.

4. A rotatable thermoforming machine according to any preceding claim wherein the machine comprises a group of filling nozzles, each nozzle being arranged to fill a different compartment of a multi-compartment pouch.

5. A rotatable thermoforming machine according to claim 4 wherein each filling nozzle in the group moves in a different predetermined path.

6. A rotatable thermoforming machine according to any preceding claim wherein movement of the or each filling nozzle is driven by one of: a linear servomotor; a servo with a rack and pinion drive; an air cylinder; a magnetic device providing two electrically activated magnets for X and Y movement, or combinations thereof.

7. A rotatable thermoforming machine according to claim 6 wherein the X and Y movement is translated by one of: a slide; a robotic arm motion; a mechanical assembly, or a combination thereof.

8. A rotatable thermoforming machine according to any preceding claim wherein the or each nozzle is arranged to follow a predetermined path as the or each respective pocket is filled from the filling nozzle.

9. A rotatable thermoforming machine according to any preceding claim wherein the rotatable forming means comprises one of a rotatable drum and a rotatable endless belt.

10. A rotatable thermoforming machine according to any preceding claim wherein the machine applies a lidding web to close the pocket and form a pouch and wherein at least one of the first web and the lidding web comprises a soluble polymeric substrate and wherein optionally the polymeric substrate is soluble in an aqueous medium.

11. A rotatable thermoforming machine according to any preceding claim wherein the machine is arranged to fill a pouch having at least one of a circular annular compartment; a curved compartment; a compartment arranged at an angle to the machine direction; a compartment having a non-linear shape.

12. A rotatable thermoforming machine according to any preceding claim wherein the former is arranged to fill the pockets with at least one of a granular filler; a powder filler; a liquid injector; a gel injector and a tablet injector.

13. A rotatable thermoforming machine according to any preceding claim wherein the shape of the filling nozzle opening is modified to achieve an extended filling time.

14. A rotatable thermoforming machine according to any preceding claim wherein the machine is one of a continuous motion rotatable thermoforming machine and an intermittent motion rotatable thermoforming machine.

15. A method of filling a water soluble pocket comprising at least one water-soluble substrate web, the method comprising:
providing a rotatable forming means having a plurality of pocket forming cavities, the pocket forming cavities travelling in a machine direction defined as the X-direction;
forming the web into the cavities to provide a pocket;
bringing a filling means into register with one or more of the pockets;
filling the or each pocket with at least one component;
wherein the or each filling means moves in at least the X-direction as the or each respective pocket is filled from the filling means.

16. A method of filling a water soluble pocket according to claim 15 wherein the filling means comprises at least one nozzle and the or each nozzle is moveable in the X-direction and a direction transverse to the X-direction defined as the Y-direction, or a combination of the X and Y directions as the respective pocket is filled.

17. A method of filling a water soluble pocket according to claim 15 or claim 16 wherein movement of the or each filling nozzle or a group of filling nozzles is driven by one or more of: a linear servomotor; a servo with a rack and pinion drive; an air cylinder; a magnetic device providing two electrically activated magnets for X and Y movement, or combinations thereof and wherein optionally the movement is translated by one of: a slide; a robotic arm motion; a mechanical assembly, or a combination thereof.

18. A method of filling a water soluble pocket according to any one of claims 15 to 17 wherein the filling nozzle is arranged to move in register with the or each pocket until the filling is completed.

19. A method of filling a water soluble pocket according to any one of claims 15 to 17 wherein the or each nozzle follows a predetermined path which is selected to optimise filling of the or each respective pocket and wherein optionally a control means controls the or each filling nozzle to follow the predetermined path.

20. A method of filling a water soluble pocket according to any one of claims 15 to 19 wherein the or each pocket is filled with at least two components, wherein optionally the components do not mix.

21. A method of filling a water soluble pocket according to any one of claims 15 to 20 wherein the or each pocket is closed by a lidding web.

22. A method of filling a water soluble pocket according to any one of claims 15 to 21 further comprising forming and filling open pockets in each of a first and second continuous rotatable forming machines, closing the filled, open pockets in one of the first and second machines with a lidding web and closing the filled, open pockets in the other of the first and second machines with either the lidding web of the filled, closed pockets of said one of the first and second machines or with a further lidding web and combining the filled, closed pockets of said first and second machines.

23. A method of filling a water soluble pocket according to any one of claims 15 to 22 wherein rotatable forming means is provided by one of a continuous motion rotatable thermoforming machine and an intermittent motion rotatable thermoforming machine.
